(19) United States
(12) Patent Application Publication
(10) Pub. No.: US 2023/0001846 A1
(43) Pub. Date: Jan. 5, 2023

(54) VEHICLE LAMP

(71) Applicant: KOITO MANUFACTURING CO., LTD., Tokyo (JP)

(72) Inventor: Takashi HORI, Shizuoka-shi, Shizuoka (JP)

(73) Assignee: KOITO MANUFACTURING CO., LTD., Tokyo (JP)

(21) Appl. No.: 17/784,963

(22) PCT Filed: Nov. 18, 2020
(86) PCT No.: PCT/JP2020/043066

§ 371 Date: Jun. 13, 2022

(30) Foreign Application Priority Data
Dec. 16, 2019 (JP) 2019-226552

(51) Int. Cl. B60Q 1/08; B60Q 1/18; B62J 6/02; F21S 41/151; F21S 41/663

(52) U.S. Cl. CPC B60Q 1/08; B60Q 1/18; B62J 6/02; F21S 41/151; F21S 41/663

(57) ABSTRACT

A headlamp includes a high beam lamp unit configured to form a high beam light distribution pattern, a cornering lamp configured to form a side light distribution pattern, and a lamp control unit configured to control the high beam lamp unit and the cornering lamp so as to adjust the high beam light distribution pattern and the side light distribution pattern. At least one of the high beam light distribution pattern and the side light distribution pattern includes a first region including a target object and a second region other than the first region. When an external sensor detects the target object, the lamp control unit adjusts the high beam light distribution pattern and the side light distribution pattern so that at least the second region is irradiated with light.

### TECHNICAL FIELD

The present disclosure relates to a vehicle lamp.

### BACKGROUND ART

As a headlamp for a two-wheeled motor vehicle, there is a sub-headlight source, in addition to high beam/low beam light sources (PTL 1).

### CITATION LIST

### Patent Literature

PTL 1: JP-A-2007-35637

### SUMMARY OF INVENTION

### Technical Problem

In a two-wheeled motor vehicle, a driver moves the center of gravity when turning left or right, and tilts a vehicle body in a turning direction, thereby traveling around a corner while increasing a bank angle. Since a light distribution pattern that is formed by the headlight in association with the bank angle also tilts with respect to the horizontal direction, an amount of light of the headlight in the turning direction may be insufficient and the distant visibility may deteriorate. On the other hand, it is known to control a high beam/low beam and a sub-beam according to the bank angle (PTL 1). However, PTL 1 does not adjust the light distribution, in consideration of a target object including an oncoming vehicle, and therefore, there is room for improvement in the light distribution adjustment, from a viewpoint of driving assistance.

An object of the present disclosure is to provide a vehicle lamp configured to form, as a light distribution pattern including a side light distribution pattern, an appropriate light distribution pattern, in consideration of a target object.

### Solution to Problem

A vehicle lamp of the present disclosure is a vehicle lamp provided to a vehicle configured to travel around a corner by tilting a vehicle body in a turning direction, the vehicle lamp including:

a first lamp configured to form a high beam light distribution pattern;

a second lamp configured to form a side light distribution pattern;

an external sensor configured to detect a target object; and

a control unit configured to control the first lamp and the second lamp so as to adjust the high beam light distribution pattern and the side light distribution pattern,

wherein at least one of the high beam light distribution pattern and the side light distribution pattern includes a first region including the target object and a second region other than the first region, and

wherein when the external sensor detects the target object, the control unit adjusts the high beam light distribution pattern and the side light distribution pattern so that at least the second region is irradiated with light.

According to the vehicle lamp of the present disclosure, since at least the second region is irradiated with light, an amount of light of the lamp can be secured, regardless of presence of the target object.

### Advantageous Effects of Invention

According to the vehicle lamp of the present disclosure, it is possible to provide a vehicle lamp configured to form, as a light distribution pattern including a side light distribution pattern, an appropriate light distribution pattern, in consideration of a target object.

### BRIEF DESCRIPTION OF DRAWINGS

FIG.1 is a perspective view of a vehicle having a headlamp (vehicle lamp) of the present disclosure.

FIG.2 is a block diagram of the headlamp of FIG.1.

FIG.3 is a cross-sectional view showing a configuration of a high beam lamp unit of the headlamp.

FIG.4 is a perspective view showing a configuration of a light source unit of the high beam lamp unit.

FIG.5 shows a light distribution pattern when the vehicle travels in a state perpendicular to a road surface.

FIG.6 shows a light distribution pattern when the vehicle travels in a state tilted with respect to the road surface.

FIG.7 shows a light distribution pattern when an external sensor detects a pedestrian.

### DESCRIPTION OF EMBODIMENTS

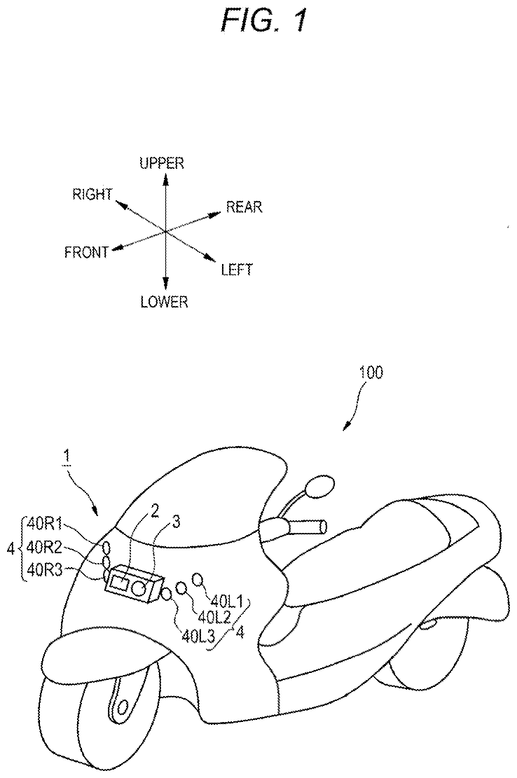

Embodiments of the present disclosure will be described with reference to the drawings. Note that, the “right and left direction”, the “front and rear direction”, and the “upper and lower direction” in the present embodiment are relative directions set for a two-wheeled motor vehicle 100 shown in FIG.1 for convenience of description.

### First Embodiment

FIG.1 shows a two-wheeled motor vehicle 100, as an example of the vehicle according to a first embodiment. The two-wheeled motor vehicle 100 is a vehicle capable of traveling along a corner (curve) of a road by tilting a vehicle body in a turning direction. The vehicle of the present embodiment may be a vehicle such as the two-wheeled motor vehicle 100, which can travel around the corner by tilting the vehicle body in the turning direction, and the number of wheels is not limited. Therefore, for example, even a three-wheeled motor vehicle, a four-wheeled motor vehicle or the like is included in the vehicle of the present embodiment, as long as it can travel in the same manner as the two-wheeled motor vehicle 100.

As shown in FIG.1, a headlamp 1 according to the present embodiment is mounted on a front part of the two-wheeled motor vehicle 100. The headlamp 1 is a lamp that can irradiate the front of the vehicle with light. The headlamp 1 includes a low beam lamp unit 2, a high beam lamp unit 3, and cornering lamps 4. In the present embodiment, a pair of cornering lamps 4 is provided in the right and left direction of the vehicle body, but the present invention is not limited to this configuration. The headlamp 1 is an example of the vehicle lamp. The high beam lamp unit 3 is an example of the first lamp. The cornering lamp 4 is an example of the sub-lamp.

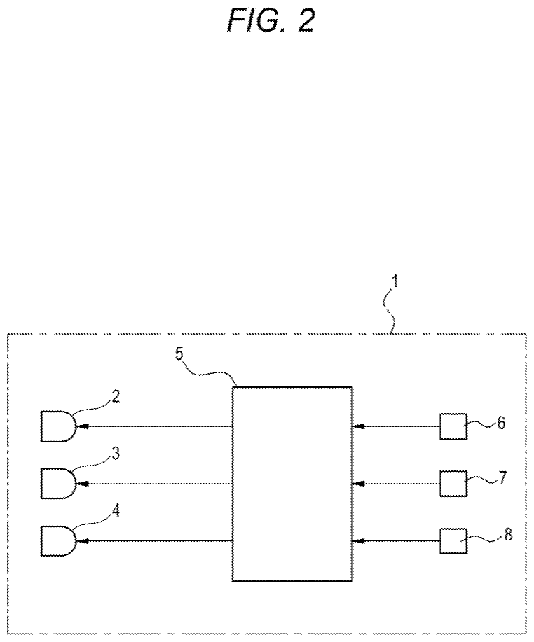

As shown in FIG.2, the headlamp 1 includes a lamp control unit 5. The lamp control unit 5 is connected to the low beam lamp unit 2, the high beam lamp unit 3, and the cornering lamps 4. The lamp control unit 5 is configured to control the low beam lamp unit 2, the high beam lamp unit 3, and the cornering lamps 4. The lamp control unit 5 is also electrically connected to a bank angle sensor 6, an external sensor 7, a speed sensor 8, and the like. The lamp control unit 5 is an example of the control unit.

The bank angle sensor 6 is configured to detect a tilt state of the two-wheeled motor vehicle 100. Specifically, the bank angle sensor 6 is a sensor capable of detecting a tilt angle when the vehicle body of the two-wheeled motor vehicle 100 is tilted to the left or right with respect to a vertical line. The bank angle sensor 6 is configured by, for example, a gyro sensor. Note that, the tilt angle of the vehicle body may also be calculated based on an image captured by a camera mounted on the vehicle body, for example.

The external sensor 7 is configured to detect environmental information outside the vehicle, such as a target object. Specifically, the external sensor 7 is a sensor that can acquire information on an outside of the own vehicle, including surrounding environment of the two-wheeled motor vehicle 100 (for example, obstacles, other vehicles (preceding vehicle, oncoming vehicle), pedestrians, road shapes, traffic signs, and the like). The external sensor 7 is configured by, for example, at least one of LiDAR (Light Detection and Ringing or Laser Imaging Detection and Ranking), a camera, a radar, and the like. The speed sensor 8 is configured to detect a speed of the two-wheeled motor vehicle 100.

Each information detected by the bank angle sensor 6, the external sensor 7, and the speed sensor 8 is transmitted to the lamp control unit 5. The lamp control unit 5 is configured to control the low beam lamp unit 2, the high beam lamp unit 3, and the cornering lamps 4, based on the information transmitted from each of the bank angle sensor 6, the external sensor 7, and the speed sensor 8. For example, the lamp control unit 5 can control the headlamp 1, based on the detection results of the bank angle sensor 6, the external sensor 7, and the speed sensor 8, to adjust a light distribution pattern that is formed ahead of the vehicle. That is, the lamp control unit 5 can control the low beam lamp unit 2, the high beam lamp unit 3, and the cornering lamps 4, based on the detection results of the bank angle sensor 6, the external sensor 7, and the speed sensor 8, to adjust a low beam light distribution pattern, a high beam light distribution pattern and a side light distribution pattern.

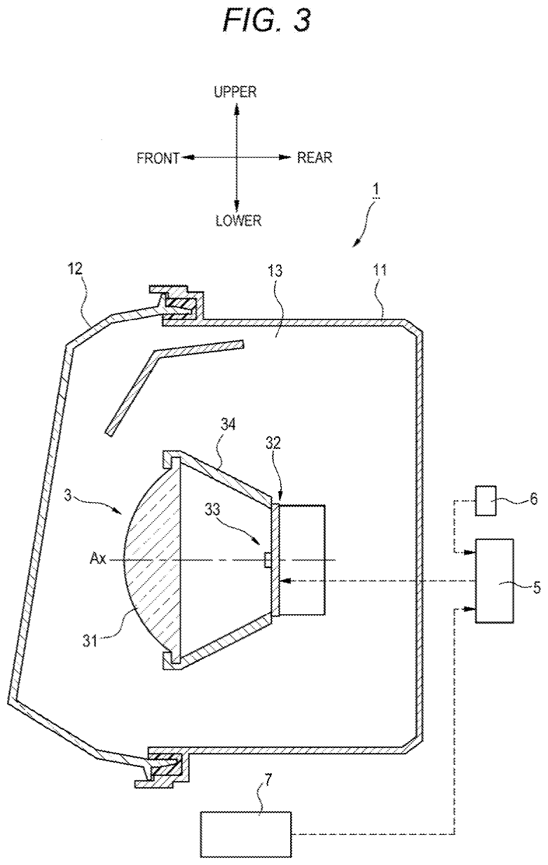

FIG.3 is a vertical cross-sectional view showing a schematic configuration of the high beam lamp unit 3 of the headlamp 1. As shown in FIG.3, the headlamp I includes a lamp body 11 having an opening on a front side of the vehicle, and a transparent front cover 12 attached so as to cover the opening of the lamp body 11. A lamp chamber 13 is formed by the lamp body 11 and the front cover 12. The high beam lamp unit 3 is arranged inside the lamp chamber 13. The lamp control unit 5, the bank angle sensor 6, the external sensor (for example, LiDAR) 7, and the like are arranged outside the lamp chamber 13. Although not shown in the cross-sectional view of FIG.3, the low beam lamp unit 2 is accommodated in the lamp chamber 13 of the headlamp 1, like the high beam lamp unit 3. The cornering lamps 4 are arranged outside the lamp chamber 13.

The high beam lamp unit 3 is a so-called projector type lamp unit. The high beam lamp unit 3 is an example of the first lamp. The high beam lamp unit 3 includes a projection lens 31, a light source unit 32, and a holder 34 configured to hold the projection lens 31 and the light source unit 32. The light source unit 32 has a high beam light source 33. The holder 34 is configured to hold the projection lens 31 and the light source unit 32.

The projection lens 31 is a plano-convex aspherical lens having a convex front surface and a flat rear surface. The projection lens 31 is arranged on an optical axis Ax extending in the front and rear direction of the vehicle. A peripheral edge portion of the projection lens 31 is held on a front end-side of the holder 34. The projection lens 31 is configured to irradiate the light from the light source 33 toward the front of the lamp to form a predetermined high beam light distribution pattern.

The light source unit 32 is arranged so that the light source 33 faces forward in the direction of the optical axis Ax, and is held on a rear end-side of the holder 34. The light source 33 is electrically connected to the lamp control unit 5.

The holder 34 is attached to the lamp body 11 via a support member (not shown).

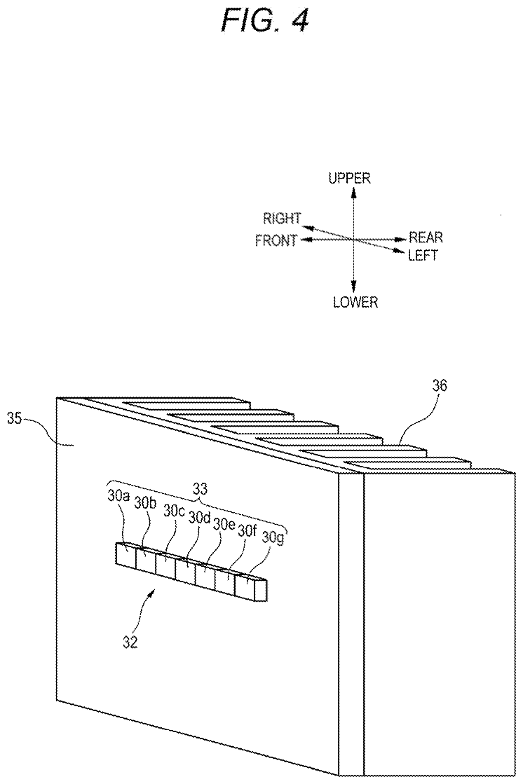

FIG.4 is a perspective view showing a schematic structure of the light source unit 32 of the high beam lamp unit 3. The light source unit 32 has the light source 33, a support plate 35, and a heat sink 36. The light source 33 has a plurality of individual light sources 30 configured by light emitting elements such as light emitting diodes (LEDs). The light source 33 has, for example, individual light sources 30a to 30g arranged in parallel in 7 columns and 1 row, and is fixed to a front surface of the support plate 35. The individual light sources 30a to 30g are configured as an LED array. Each of the individual light sources 30a to 30g is electrically connected to the lamp control unit 5. The individual light sources 30a to 30g are independently controlled to irradiate light by the lamp control unit 5 in an ADB (Adaptive Driving Beam) mode described later. Note that, the individual light sources 30a to 30g are arranged in parallel in the right and left direction (direction orthogonal to the optical axis Ax). The number and arrangement of the individual light sources 30 are not particularly limited.

The heat sink 36 is a member for dissipating heat generated from the light source 33, and is held on a surface of the support plate 35 facing toward a rear side of the vehicle. The light source unit 32 is fixed to the holder 34 via the support plate 35.

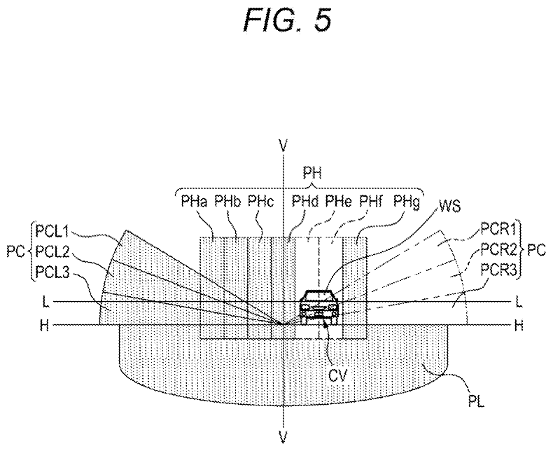

Next, light distribution patterns that are formed by the headlamp I mounted on the two-wheeled motor vehicle 100 are described with reference to FIGS. 5 to 7.

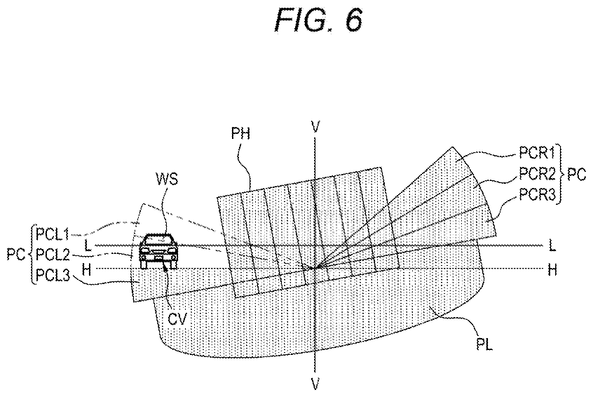

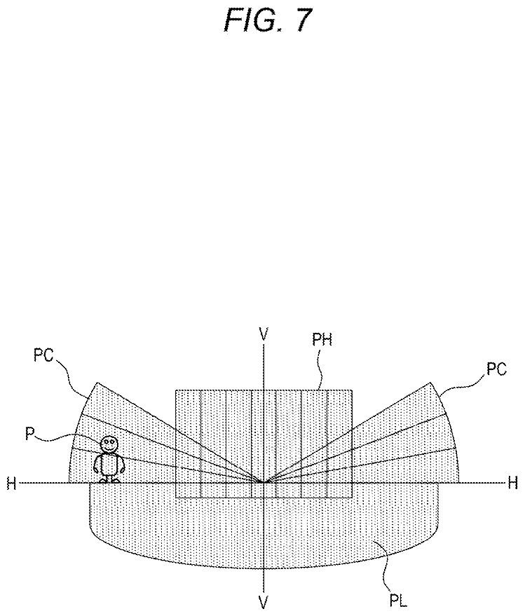

FIGS. 5 to 7 show light distribution patterns formed on a virtual vertical screen arranged at a predetermined position ahead of the lamp, for example, a position 25 m ahead of the lamp. In FIGS. 5 to 7, HH indicates a horizontal direction (horizontal line H), and VV indicates a vertical direction. FIGS. 5 and 6 show light distribution patterns when a target object is an oncoming vehicle CV. The target object may also include a preceding vehicle. FIG.7 shows a light distribution pattern when the target object is a pedestrian P.

In FIGS. 5 to 7, a high beam light distribution pattern PH is a light distribution pattern that is formed by the high beam lamp unit 3. A low beam light distribution pattern PL is a light distribution pattern that is formed by the low beam lamp unit 2. A side light distribution pattern PC is a light distribution pattern that is formed by the cornering lamp 4.

FIG.5 shows a light distribution pattern when the two-wheeled motor vehicle 100 travels in a state where the vehicle body is perpendicular to the road surface. For example, FIG.5 shows a light distribution pattern when the two-wheeled motor vehicle 100 travels on a straight road without tilting the vehicle body.

The light irradiated from the high beam lamp unit 3 is irradiated to the front of the vehicle to form a high beam light distribution pattern PH. Specifically, the individual light source 30a of the high beam lamp unit 3 forms a partial pattern PHa. The individual light source 30b forms a partial pattern PHb. The individual light source 30c forms a partial pattern PHc. The individual light source 30d forms a partial pattern PHd. The individual light source 30e forms a partial pattern PHe. The individual light source 30f forms a partial pattern PHf. The individual light source 30g forms a partial pattern PHg. The partial patterns PHa to PHg are synthesized to form the high beam light distribution pattern PH. In the present embodiment, since the high beam lamp unit 3 includes a total of seven individual light sources 30a to 30g, as shown in FIG.4, the seven partial patterns PHa to PHg are formed, as shown in FIG.5. The high beam lamp unit 3 forms a plurality of high beam light distribution patterns PH having different shapes according to the oncoming vehicle CV by combining formation and non-formation of each partial pattern PHa to PHg in the ADB mode described later.

The light irradiated from the cornering lamp 4 is irradiated to the front of the vehicle to form a side light distribution pattern PC. For example, as shown in FIG.1, the cornering lamps 4 include a plurality of individual light sources 40. Specifically, the cornering lamps 4 include individual light sources 40R1, 40R2 and 40R3 on the right side and individual light sources 40L1, 40L2 and 40L3 on the left side. The individual light sources 40R1, 40R2, and 40R3 form partial patterns PCR1, PCR2, and PCR3, respectively. The individual light sources 40L1, 40L2, and 40L3 form partial patterns PCL1, PCL2, and PCL3, respectively. The partial patterns PCR1, PCR2, PCR3, PCLI, PCL2 and PCL3 are synthesized to form the side light distribution patterns PC. The side light distribution pattern PC is a light distribution pattern that is additionally formed with respect to the high beam light distribution pattern PH. The side light distribution pattern PC is formed further enlarged in the right and left direction of the vehicle body than at least the high beam light distribution pattern PH. In the present embodiment, the cornering lamps 4 are provided with the three individual light sources on each of the left and right sides, but the number of individual light sources may be increased or decreased. The cornering lamps 4 form a plurality of side light distribution patterns PH having different shapes according to the oncoming vehicle CV by combining formation and non-formation of each partial pattern PCR1, PCR2, PCR3, PCL1, PCL2 and PCL3 in the ADB mode described later.

FIG.5 shows a light distribution pattern in which the high beam light distribution pattern PH and the side light distribution patterns PC overlap each other. However, the lamp control unit 5 may form a light distribution pattern so that the high beam light distribution pattern PH and the side light distribution patterns PC do not overlap each other.

Subsequently, the ADB mode that is executed by the lamp control unit 5 is described. The lamp control unit 5 detects a status of the oncoming vehicle CV including presence or absence of the oncoming vehicle CV and an existing position of the oncoming vehicle CV, based on the environmental information acquired by the external sensor 7, for example. The existing position of the oncoming vehicle CV includes a distance from the two-wheeled motor vehicle 100 to the oncoming vehicle, position coordinates of the oncoming vehicle on the virtual vertical screen, and the like. In addition, the lamp control unit 5 detects a tilt of the vehicle body, based on the tilt angle information of the vehicle body acquired by the bank angle sensor 6, for example. Further, the lamp control unit 5 detects a traveling status of the two-wheeled motor vehicle 100, including traveling or stop of the two-wheeled motor vehicle 100, based on the speed information acquired by the speed sensor 8, for example. The lamp control unit 5 controls the light distribution pattern, based on the information acquired by the external sensor 7, the bank angle sensor 6, and the speed sensor 8.

When the lamp control unit 5 acquires the environmental information from the external sensor 7, the lamp control unit 5 individually controls lighting and lights-out of the plurality of individual light sources 30 of the high beam lamp unit 3, based on the detection result, and also individually controls the lighting and lights-out of the plurality of individual light sources 40 of the cornering lamps 4. Specifically, the lamp control unit 5 controls each of the plurality of individual light sources 30 of the high beam lamp unit 3 to turn on the individual light sources 30 of the partial patterns to be used for light irradiation of the high beam light distribution pattern PH among the plurality of individual light sources 30a to 30g and to turn off the individual light sources 30 of the partial patterns not to be used for light irradiation of the high beam light distribution pattern PH. Similarly, the control unit 5 controls each of the plurality of individual light sources 40 of the cornering lamps 4 to turn on the individual light sources 40 of the partial patterns to be used for light irradiation of the side light distribution patterns PC among the plurality of individual light sources 40 and to turn off the individual light sources 40 of the partial patterns not to be used for light irradiation of the side light distribution patterns PC. The lamp control unit 5 may control the high beam lamp unit 3 and the cornering lamps 4, in conjunction with each other or individually and independently.

When the external sensor 7 detects an oncoming vehicle CV, at least one of the high beam light distribution pattern PH and the side light distribution patterns PC includes a region where the oncoming vehicle CV is present. In the light distribution pattern, the region including the oncoming vehicle CV is defined as a first region, and a region not including the oncoming vehicle CV, i.e., a region other than the first region is defined as a second region. FIG.5 shows a state in which the high beam light distribution pattern PH includes the first region and the second region, and the side light distribution patterns PC also include the first region and the second region. However, at least one of the high beam light distribution pattern PH and the side light distribution patterns PC may include the first region and the second region.

When the external sensor 7 detects the oncoming vehicle CV, the lamp control unit 5 adjusts the high beam light distribution pattern PH and the side light distribution patterns PC so that at least the second region is irradiated with light. In FIG.5, the partial patterns PHa, PHb, PHc, PHd and PHg are the second region not including the oncoming vehicle CV. The lamp control unit 5 turns on the individual light sources 30a to 30d and 30g of the plurality of individual light sources 30 of the high beam lamp unit 3 so as to irradiate the second region with light. Similarly, the partial patterns PCL1, PCL2, and PCL3 are the second region not including the oncoming vehicle CV. The lamp control unit 5 turns on the individual light sources 40L1 to 40L3 of the plurality of individual light sources 40 of the cornering lamps 4 so as to irradiate the second region with light.

According to the present embodiment, when the external sensor 7 detects the oncoming vehicle CV, at least the second region is irradiated with light, so that an amount of light of the lamp for the second region is secured, regardless of the presence of the oncoming vehicle CV. Therefore, it is possible to improve the visibility at the time of driving assistance.

In the present embodiment, when the external sensor 7 detects the oncoming vehicle CV, both the high beam lamp unit 3 and the cornering lamps 4 are controlled to irradiate at least the second region with light. Therefore, the amounts of light of the two lamps for the second region can be secured, regardless of the presence of the oncoming vehicle CV, so that the visibility at the time of driving assistance can be improved. In particular, since the cornering lamp 4 is more suitable for light irradiation to the side of the vehicle body, as compared to the high beam lamp unit 3, it is possible to form a light distribution pattern in a wide range in the right and left direction of the vehicle body. In the cornering lamp 4 of the present embodiment, the side light distribution pattern PC can be adjusted, in consideration of a target object including the oncoming vehicle CV.

In the present embodiment, when the external sensor 7 detects the oncoming vehicle

CV, the lamp control unit 5 may adjust the high beam light distribution pattern PH and the side light distribution patterns PC so that the first region is not irradiated with light. In FIG.5, the partial patterns PHe and PHf are the first region including the oncoming vehicle CV. The lamp control unit 5 turns off the individual light sources 30e and 30f, which correspond to the partial patterns PHe and PHf, of the plurality of individual light sources 30 of the high beam lamp unit 3. Similarly, the partial patterns PCR1 to PCR3 are the first region including the oncoming vehicle CV. The lamp control unit 5 turns off the individual light sources 40R1 to 40R3, which correspond to the partial patterns PCR1 to PCR3, of the plurality of individual light sources 40 of the cornering lamps 4.

According to the present embodiment, since the first region including the oncoming vehicle CV is not irradiated with light, glare to the driver of the oncoming vehicle CV can be prevented.

In FIG.5, when the external sensor 7 detects the oncoming vehicle CV, the lamp control unit 5 turns on the individual light sources 40L1 to 40L3 of the cornering lamps 4 so as to irradiate the second region with light, and turns off the individual light sources 40R1 to 40R3 of the cornering lamps 4 so as not to irradiate the first region with light, thereby adjusting the side light distribution patterns PC. However, when the external sensor 7 detects the oncoming vehicle CV, the lamp control unit 5 may adjust the side light distribution patterns PC by turning off all the individual light sources 40 of the cornering lamps 4. That is, in FIG.5, when the external sensor 7 detects the oncoming vehicle CV, the lamp control unit 5 irradiates the second region with light by both the high beam lamp unit 3 and the cornering lamps 4. However, when the external sensor 7 detects the oncoming vehicle CV, the high beam light distribution pattern and the side light distribution patterns PC may also be adjusted so that the second region is irradiated with light only by the high beam lamp unit 3. In this case, the lamp control unit 5 can adjust the side light distribution patterns PC just by switching on and off of the cornering lamps 4 according to the detection result of the external sensor 7. Therefore, it is possible to simplify the control of the cornering lamps 4 while preventing glare to the driver of the oncoming vehicle CV.

The lamp control unit 5 of the present embodiment may also adjust the side light distribution patterns PC so that a predetermined reference line L and a region below the reference line L are irradiated with light. The reference line L is a line extending in the right and left direction of the vehicle body and parallel to the horizontal line H, and has a predetermined height from the horizontal line H. For example, the reference line L has a predetermined height from the horizontal line H at a position of a target object, but is not limited thereto.

When there is an individual light source, which forms a partial pattern corresponding to the reference line L and the region below the reference line L, in the plurality of individual light sources 40 of the cornering lamps 4, the lamp control unit 5 may turn on the individual light source of the partial pattern, regardless of the detection result of the external sensor 7. Although not shown, in the plurality of individual light sources 40 of the cornering lamps 4, when the lower partial patterns PCR3 and PCL3 are formed in the reference line L and the region below the reference line L, the lamp control unit 5 may continue to turn on the lower individual light sources 40R3 and 40L3, regardless of the detection result of the external sensor 7. In this case, in the present embodiment, the side light distribution patterns PC are always formed in the reference line L and the region below the reference line L, regardless of the detection result of the external sensor 7, so that the amounts of light for the reference line L and the region below the reference line L can be secured.

When the target object is either the oncoming vehicle CV or the preceding vehicle, the reference line L is preferably lower than a window glass of the oncoming vehicle CV or a window glass of the preceding vehicle. Examples of the window glass may include a front window and a rear window of a four-wheeled vehicle and a front shield of a two-wheeled vehicle. These window glasses are not limited to glass and may be made of other materials such as resin and vinyl. When the target object is the oncoming vehicle CV, the reference line L is preferably lower than a front window or windshield WS of the oncoming vehicle CV. That is, the lamp control unit 5 may adjust the high beam light distribution pattern PH or the side light distribution patterns PC so as to irradiate light to a position lower than the front window or windshield WS of the oncoming vehicle CV, regardless of the detection result of the external sensor 7. In this case, the present embodiment can secure the amount of light not only for the second region but also for the reference line L and the region below the reference line L while preventing glare to the driver of the oncoming vehicle CV. When the target object is the preceding vehicle, the reference line L is preferably lower than a rear window or an indicator light of the preceding vehicle. The reference line L may be lower than a headlight of the oncoming vehicle. That is, the lamp control unit 5 may adjust the high beam light distribution pattern PH or the side light distribution patterns PC so that the light is irradiated to a position lower than the headlight of the oncoming vehicle. In this case, in the present embodiment, since the reference line L is lower than the headlight of the oncoming vehicle, the light is not irradiated to a face of the driver of the oncoming vehicle, so that glare to the driver of the oncoming vehicle can be prevented.

FIG.6 shows a light distribution pattern when the two-wheeled motor vehicle 100 travels in a state where the vehicle body is tilted with respect to the road surface. For example, FIG.6 shows a light distribution pattern when the two-wheeled motor vehicle 100 moves to the left side of the road surface or travels on a curved road turning to the left. The bank angle of the vehicle body is not limited, but the bank angle is, for example, 10 degrees, 20 degrees, 30 degrees, or the like. Since a control method of the light distribution pattern when the two-wheeled motor vehicle 100 moves to the right side of the road surface or travels on a curved road turning to the right is the same as the control method of the light distribution pattern when the two-wheeled motor vehicle 100 moves to the left side of the road surface or travels on a curved road turning to the left, except that the left and right directions are opposite, the description thereof is omitted.

As shown in FIG.6, when the two-wheeled motor vehicle 100 travels while tilting the vehicle body with respect to the road surface, the high beam lamp unit 3 and the cornering lamps 4 are also tilted with respect to the road surface, as the vehicle body is tilted, so that the high beam light distribution pattern PH and the side light distribution patterns PC are formed tilted with respect to the horizontal direction HH. In the present embodiment, the bank angle sensor 6 detects the bank angle of the vehicle body and transmits the detection result to the lamp control unit 5. The lamp control unit 5 adjusts at least the side light distribution patterns PC so that the second region is irradiated with light, according to the tilt of the vehicle body detected by the bank angle sensor 6. Specifically, the partial patterns PCR 1 to PCR3 and PCL3 are the second region not including the oncoming vehicle CV. Therefore, the lamp control unit 5 turns on the individual light sources 40R1 to 40R3 and 40L3, which correspond to the partial patterns PCR1 to PCR3 and PCL3, of the plurality of individual light sources 40 of the cornering lamps 4. In addition, the partial patterns PCL1 and PCL2 are the first region including the oncoming vehicle CV. Therefore, the lamp control unit 5 turns off the individual light sources 40L1 and 40L2 corresponding to the partial patterns PCL1 and PCL2.

According to the present embodiment, even when the vehicle body is tilted, the second region, which is a region not including the oncoming vehicle, is irradiated with light, according to the tilt of the vehicle body, so that the amount of light for the second region can be secured. Additionally, according to the present embodiment, even when the vehicle body is tilted, the first region including the oncoming vehicle CV is not irradiated with light, so that glare to the driver of the oncoming vehicle CV can be prevented.

The lamp control unit 5 of the present embodiment may adjust the side light distribution patterns PC so that the reference line L and the region below the reference line L are irradiated with light even when the vehicle body is tilted. Although not shown, when the central partial pattern PCL2 is below the reference line, the central individual light source 40L2 of the individual light sources 40L1 to 40L3 of the cornering lamps may be continuously turned on, regardless of the detection result of the external sensor 7. In this case, even when the vehicle body is tilted, the side light distribution patterns PC are always formed in the reference line L and the region below the reference line L, regardless of the detection result of the external sensor 7, so that the amounts of light for the reference line L and the region below the reference line L can be secured.

The target object has been described as the oncoming vehicle CV in FIGS. 5 and 6, but the target object may also be the pedestrian P. When the target object is the oncoming vehicle CV, as shown in FIGS. 5 and 6, in order to prevent glare to the driver of the oncoming vehicle CV, the lamp control unit 5 adjusts the high beam light distribution pattern PH and the side light distribution patterns PC so that the first region including the oncoming vehicle CV is not irradiated with light. On the other hand, when the target object is the pedestrian P, the pedestrian P is preferably irradiated with light so that the driver of the two-wheeled motor vehicle 100 can recognize the pedestrian P, from a viewpoint of visibility at the time of driving assistance. That is, as shown in FIG.7, when the external sensor 7 detects the pedestrian P, the lamp control unit 5 preferably adjusts the high beam light distribution pattern PH and the side light distribution patterns PC so that not only the second region not including the pedestrian P but also the first region including the pedestrian P is irradiated with light. In this case, since the first region including the pedestrian P is irradiated with light, the driver of the two-wheeled motor vehicle 100 can reliably visually recognize the pedestrian P, so that the visibility of the driving assistance can be improved.

When the external sensor 7 detects the pedestrian P, the high beam light distribution pattern PH and the side light distribution patterns PC may be adjusted so that the face of the pedestrian P is not irradiated with light and the body and the like of the pedestrian P are irradiated with the light. In this case, an area other than the face of the pedestrian P is the first region. Since the first region not including the face of the pedestrian P is irradiated with light, the driver of the two-wheeled motor vehicle 100 can prevent glare to the pedestrian P while visually recognizing the pedestrian P, so that the visibility of the driving assistance can be improved.

Although the embodiment of the present disclosure has been described, it goes without saying that the technical scope of the present disclosure should not be construed as being limited by the description of the present embodiment. It is understood by those skilled in the art that the present embodiment is just an example and the embodiment can be variously changed within the scope of the invention described in the claims. The technical scope of the present disclosure should be determined based on the scope of the invention described in the claims and the equivalent scope thereof.

In the above embodiment, the cornering lamps 4, the lamp control unit 5, and the external sensor 7 are accommodated outside the lamp chamber 13 of the headlamp 1. However, for example, the lamp control unit 5 or the cornering lamps 4 may also be accommodated inside the lamp chamber 13 of the headlamp 1.

The present application is based on Japanese Patent Application No. 2019-226552 filed on Dec. 16, 2019, the contents of which are incorporated herein by reference.

1. A vehicle lamp to be provided to a vehicle configured to travel around a corner by tilting a vehicle body in a turning direction, the vehicle lamp comprising:
a first lamp configured to form a high beam light distribution pattern;
a second lamp configured to form a side light distribution pattern;
an external sensor configured to detect a target object; and
a control unit configured to control the first lamp and the second lamp so as to adjust the high beam light distribution pattern and the side light distribution pattern,
wherein at least one of the high beam light distribution pattern and the side light distribution pattern includes a first region including the target object and a second region other than the first region, and
wherein when the external sensor detects the target object, the control unit adjusts the high beam light distribution pattern and the side light distribution pattern so that at least the second region is irradiated with light.

2. The vehicle lamp according to claim 1, wherein when the external sensor detects the target object, the control unit turns off the second lamp.

3. The vehicle lamp according to claim 1, wherein the control unit is configured to adjust at least the side light distribution pattern so that the second region is irradiated with light, according to a tilt of the vehicle body.

4. The vehicle lamp according to claim 1, wherein the control unit is configured to adjust the side light distribution pattern so that a predetermined reference line or a region below the reference line is irradiated with light, regardless of a detection result of the external sensor, and
wherein the reference line is a line extending in a right and left direction of the vehicle body and parallel to a horizontal line, and has a predetermined height from the horizontal line.

5. The vehicle lamp according to claim 1, wherein the target object comprises at least one of an oncoming vehicle or a preceding vehicle, and
wherein when the external sensor detects the oncoming vehicle or the preceding vehicle, the control unit adjusts the high beam light distribution pattern and the side light distribution pattern so that the first region is not irradiated with light.

6. The vehicle lamp according to claim 4, wherein the target object comprises at least one of an oncoming vehicle or a preceding vehicle, and
wherein the reference line is lower than a window glass of the oncoming vehicle or a window glass of the preceding vehicle.

7. The vehicle lamp according to claim 1, wherein the target object comprises a pedestrian, and
wherein when the external sensor detects the pedestrian, the control unit adjusts at least one of the high beam light distribution pattern and the side light distribution pattern so that the first region is irradiated with light.
